(19) United States
(12) Patent Application Publication
(10) Pub. No.: US 2024/0393508 A1
(43) Pub. Date: Nov. 28, 2024

(54) OPTICAL ELEMENT DRIVING MECHANISM

(71) Applicant: TDK TAIWAN CORP., Taoyuan City (TW)

(72) Inventors: Pai-Jui CHENG, Taoyuan City (TW); Shu-Shan CHEN, Taoyuan City (TW); Chuan-Min LEE, Taoyuan City (TW)

(21) Appl. No.: 18/673,926

(22) Filed: May 24, 2024

Related U.S. Application Data
(60) Provisional application No. 63/504,648, filed on May 26, 2023.

(51) Int. Cl. G02B 5/00

(52) U.S. Cl. CPC G02B 5/005

(57) ABSTRACT

An optical element driving mechanism is provided. The optical element driving mechanism includes a movable part, a fixed part, and a sensing assembly. The movable part is used for connecting an optical element. The fixed part has an opening for allowing light to pass through. The movable part moves relative to the fixed part. The sensing assembly is used for sensing the position of the movable part relative to the fixed part. When the movable part is in a first range, the optical element at least partially overlaps the opening.

### CROSS REFERENCE TO RELATED APPLICATIONS

This application claims the benefit of U.S. Provisional Application No. 63/504,648, filed 2023 May 26, the entirety of which is incorporated by reference herein.

### BACKGROUND OF THE INVENTION

### Field of the Invention

The present invention relates to an optical element driving mechanism, and, in particular, to an optical element driving mechanism having a sensing assembly for sensing the position of a movable part relative to a fixed part.

### Description of the Related Art

With the advancement of technology, many electronic devices today, such as laptops, smartphones, or digital cameras, are equipped with photography or videography capabilities. The use of these electronic devices is becoming increasingly common, and in addition to developing more stable and higher-quality optics, they are also moving towards designs that are more convenient and lightweight, providing users with more choice. The design of electronic devices continues to trend towards miniaturization, requiring various elements or structures of optical modules used for functions like imaging to constantly downsize, in order to achieve miniaturization goals. In view of this, designing a compact driving mechanism has become an important issue.

### BRIEF SUMMARY OF THE INVENTION

The term “embodiment” and like terms, e.g., implementation, configuration, aspect, example, and option, are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter. This summary is also not intended to be used in isolation to determine the scope of the claimed subject matter. The subject matter should be understood by reference to appropriate parts of the entire specification of this disclosure, any or all drawings, and each claim.

According to certain aspects of the present disclosure, an optical element driving mechanism is provided. The optical element driving mechanism includes a movable part, a fixed part, and a sensing assembly. The movable part is for connecting an optical element. The fixed part has an opening, for allowing light to pass through. The movable part is movable relative to the fixed part. The sensing assembly is for detecting the position of the movable part relative to the fixed part. When the movable part is in a first range, the optical element at least partially overlaps with the opening.

In some embodiments of the present disclosure, when the movable part is in a first position and a second position, the sensing assembly is electrically connected to the optical element.

In some embodiments of the present disclosure, when the movable part is in the first position, the optical element is in a closed state.

In some embodiments of the present disclosure, when the movable part is in the second position, the optical element is in an open state.

In some embodiments of the present disclosure, the distance between the first position and the second position is approximately one-fourth of the total length of the optical element driving mechanism.

In some embodiments of the present disclosure, when the movable part is in the first position and the second position, the sensing assembly is in contact with the optical element.

In some embodiments of the present disclosure, when the movable part is in the first position, a first edge of the optical element is in contact with the sensing assembly.

In some embodiments of the present disclosure, when the movable part is in the second position, a second edge of the optical element is in contact with the sensing assembly.

In some embodiments of the present disclosure, the edges of the optical element in contact with the sensing assembly have a rounded corner.

In some embodiments of the present disclosure, the sensing assembly comprises a suspended wire and a circuit element, the suspended wire is laser welded to the circuit element.

In some embodiments of the present disclosure, one end of the suspended wire is dangled in the air.

In some embodiments of the present disclosure, the fixed part comprises an outer case, and an insulating element is disposed between the suspended wire and the outer case.

In some embodiments of the present disclosure, the movable part comprises a jointing part, laser welded to the optical element.

In some embodiments of the present disclosure, the optical element driving mechanism further includes a transmitting element, connected to the fixed part via a buffering element.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims. Additional aspects of the disclosure will be apparent to those of ordinary skill in the art in view of the detailed description of various embodiments, which is made with reference to the drawings, a brief description of which is provided below.

### BRIEF DESCRIPTION OF THE DRAWINGS

The disclosure, and its advantages and drawings, will be better understood from the following description of representative embodiments together with reference to the accompanying drawings. These drawings depict only representative embodiments, and are therefore not to be considered as limitations on the scope of the various embodiments or claims.

FIG. 1 is a front perspective view of an optical element driving mechanism and an optical element, according to certain aspects of the present disclosure.

FIG. 2 is an exploded perspective view of the optical element driving mechanism and the optical element, according to certain aspects of the present disclosure.

FIG. 3 is a cross-sectional view of the optical element driving mechanism and the optical element along line A-A of FIG. 1, according to certain aspects of the present disclosure.

FIG. 4 is a cross-sectional view of the optical element driving mechanism and the optical element along line B-B of FIG. 1, according to certain aspects of the present disclosure.

FIG. 5A is a top view of the optical element driving mechanism and the optical element in a first position, according to certain aspects of the present disclosure; for illustrative purposes, an outer case of the fixed part is shown in dotted lines.

FIG. 5B is a front perspective view of the optical element driving mechanism and the optical element in the first position, according to certain aspects of the present disclosure; for illustrative purposes, the outer case is not shown, the first circuit element is transparent, and the elements behind the first circuit element is shown in dotted lines.

FIG. 6A is a top view of the optical element driving mechanism and the optical element in a second position, according to certain aspects of the present disclosure; for illustrative purposes, the outer case of the fixed part is shown in dotted lines.

FIG. 6B is a front perspective view of the optical element driving mechanism and the optical element in the second position, according to certain aspects of the present disclosure; for illustrative purposes, the outer case is not shown, the second circuit element is transparent, and the elements behind the second circuit element is shown in dotted lines.

### DETAILED DESCRIPTION OF THE INVENTION

Various embodiments are described with reference to the attached FIG.s, where like reference numerals are used throughout the figures to designate similar or equivalent elements. The figures are not necessarily drawn to scale and are provided merely to illustrate aspects and features of the present disclosure. Numerous specific details, relationships, and methods are set forth to provide a full understanding of certain aspects and features of the present disclosure, although one having ordinary skill in the relevant art will recognize that these aspects and features may be practiced without one or more of the specific details, with other relationships, or with other methods. In some instances, well-known structures or operations are not shown in detail for illustrative purposes. The various embodiments disclosed herein are not necessarily limited by the illustrated ordering of acts or events, as some acts may occur in different orders and/or concurrently with other acts or events. Furthermore, not all illustrated acts or events are necessarily required to implement certain aspects and features of the present disclosure.

For purposes of the present detailed description, unless specifically disclaimed, and where appropriate, the singular includes the plural and vice versa. The word “including” means “including without limitation.” Moreover, words of approximation, such as “about,” “almost,” “substantially,” “approximately,” and the like, may be used herein to mean “at,” “near,” “nearly at,” “within 3-5% of,” “within acceptable manufacturing tolerances of,” or any logical combination thereof. Similarly, terms “vertical” or “horizontal” are intended to additionally include “within 3-5% of” a vertical or horizontal orientation, respectively. Additionally, words of direction, such as “top,” “bottom,” “left,” “right,” “above,” and “below” are intended to relate to the equivalent direction as depicted in a reference illustration; as understood contextually from the object(s) or element(s) being referenced, such as from a commonly used position for the object(s) or element(s); or as otherwise described herein.

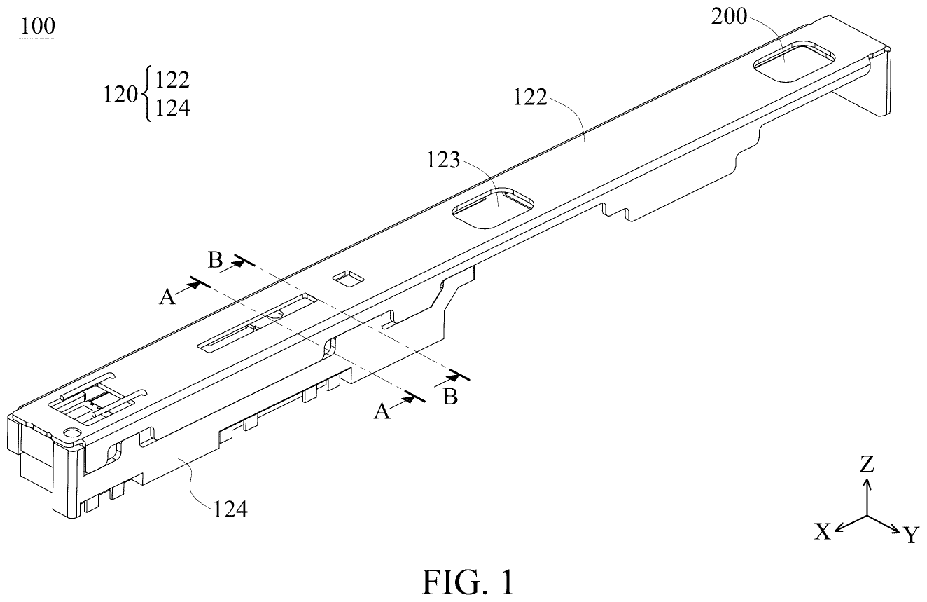

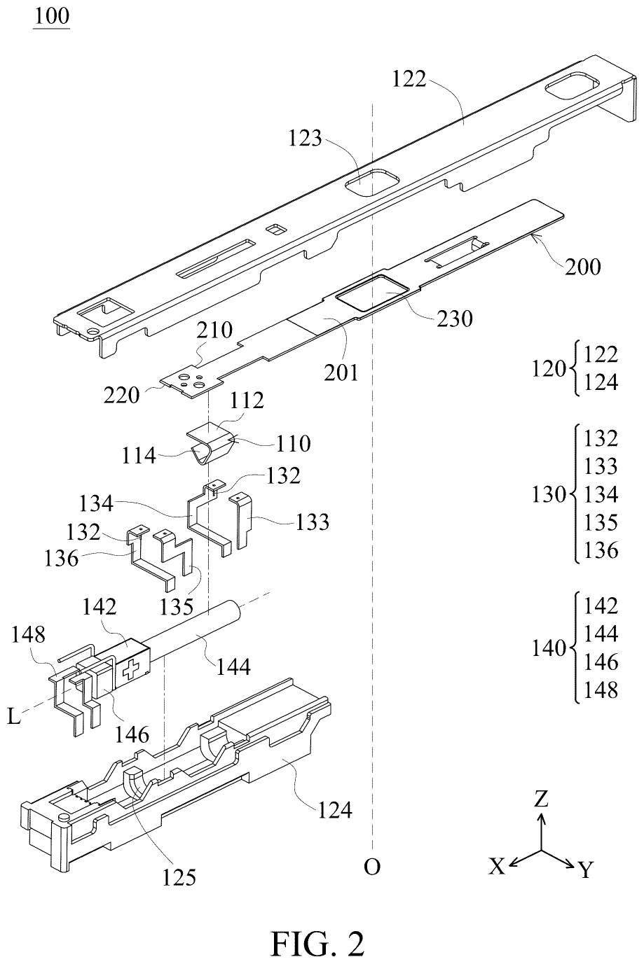

Please refer to FIG. 1 and FIG. 2 together. FIG. 1 is a front perspective view of the optical element driving mechanism 100, according to certain aspects of the present disclosure. FIG. 2 is an exploded perspective view of the optical element driving mechanism 100 and the optical element 200, according to certain aspects of the present disclosure. The optical element driving mechanism 100 includes a movable part 110, a fixed part 120, a sensing assembly 130, and a driving assembly 140. The movable part 110 is for connecting an optical element 200. The movable part 110 may move relative to the fixed part 120 between a first position and a second position. The sensing assembly 130 is for sensing the position of the movable part 110 relative to the fixed part 120. The driving assembly 140 drives the movable part 110 to move relative to the fixed part 120. The optical element driving mechanism 100 and the optical element 200 form an optical module. That is, the optical module includes the optical element driving mechanism 100 and the optical element 200.

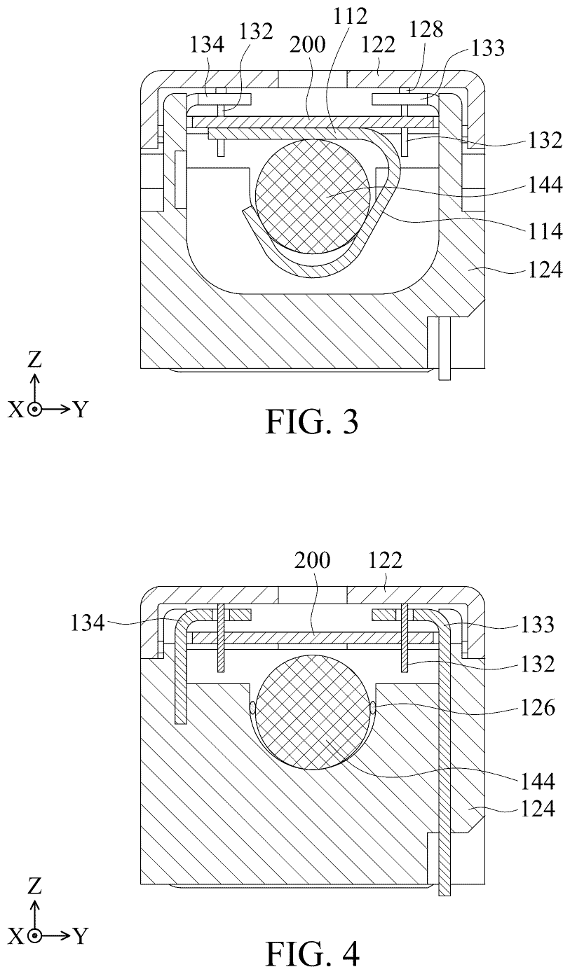

Please see FIG. 3. FIG. 3 is a sectional view of the optical element driving mechanism 100 and the optical element 200 along line A-A in FIG. 1, according to certain aspects of the present disclosure. The movable part 110 has a jointing part 112 and a gripping part 114. In some embodiments, the movable part 110 may be an integrally formed metal element, wherein the jointing part 112 is a plane and the gripping part 114 is a flexible metal sheet connected to the jointing part 112. The jointing part 112 connects to the optical element 200, for example, in some embodiments, the jointing part 112 is laser welded to the optical element 200. The gripping part 114 has a roughly V-shaped cross-section. The gripping part 114 connects to a transmitting element 144 of the driving assembly 140. As shown in FIG. 3, the gripping part 114 grips the transmitting element 144, so that when the transmitting element 144 moves (as will be further explained below), the transmitting element 144 drives the movable part 110 and the optical element 200 to move relative to the fixed part 120.

Please refer to FIG. 2 again. The fixed part 120 includes an outer case 122 and a base 124, wherein the outer case 122 is fixed to the base 124, and the space formed between the outer case 122 and the base 124 receives other components of the optical module. The outer case 122 includes an opening 123 through which an optical axis O enters the optical module. The base 124 has several grooves 125 to accommodate the transmitting element 144 of the driving assembly 140.

In some embodiments, the sensing assembly 130 has four suspension wires 132, first circuit elements 133, 134, and second circuit elements 135, 136, wherein one end of each suspension wire 132 is laser welded and electrically connected to the first circuit elements 133, 134 and the second circuit elements 135, 136. The suspension wires 132 are flexible and conductive metal wires. The first circuit elements 133, 134 and the second circuit elements 135, 136 are fixed to the base 124. The first circuit elements 133, 134 and the second circuit elements 135, 136 are electrically connected to an external controlling assembly (not shown) to transmit the sensed position information to the external controlling assembly. Referring back to FIG. 3, one end of each suspension wire 132 near the base 124 is dangled in the air. That is, one end of each suspension wire 132 is laser welded to the first circuit elements 133, 134 and the second circuit elements 135, 136 (see FIG. 2) respectively, while the other end is dangled in the air. In some embodiments, an insulating element 128 is placed between the suspension wires 132 and the outer case 122 of the fixed part 120, for example, in some embodiments, the insulating element 128 may be soft rubber.

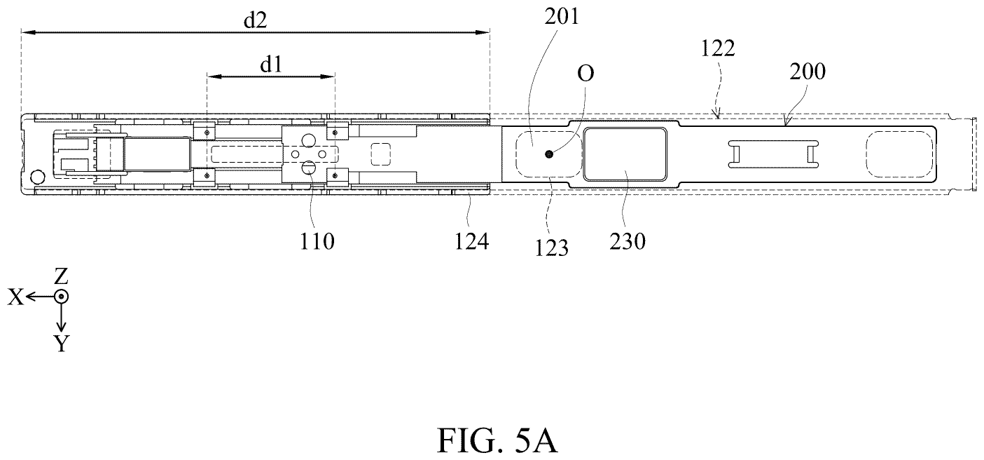

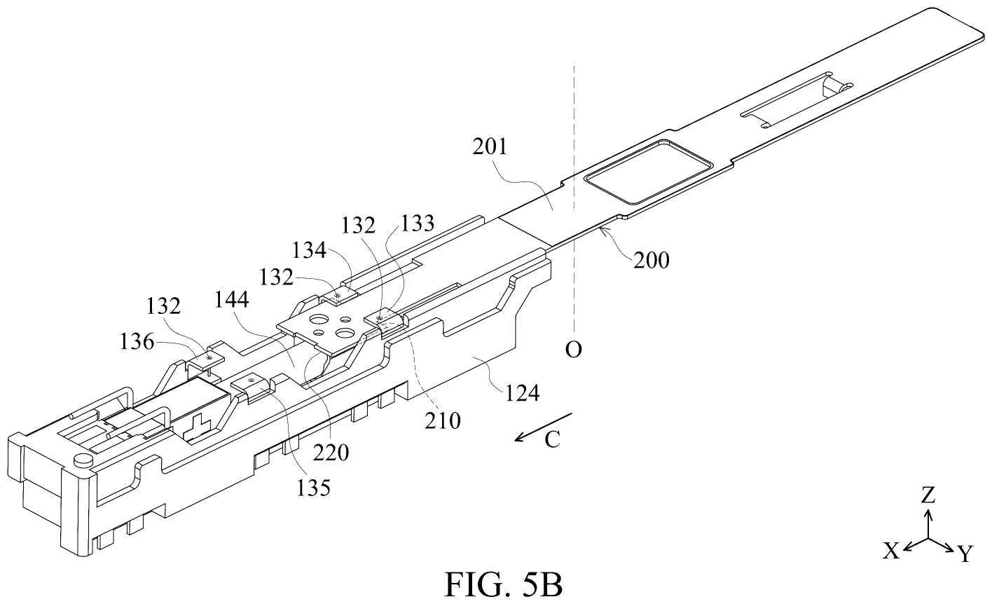

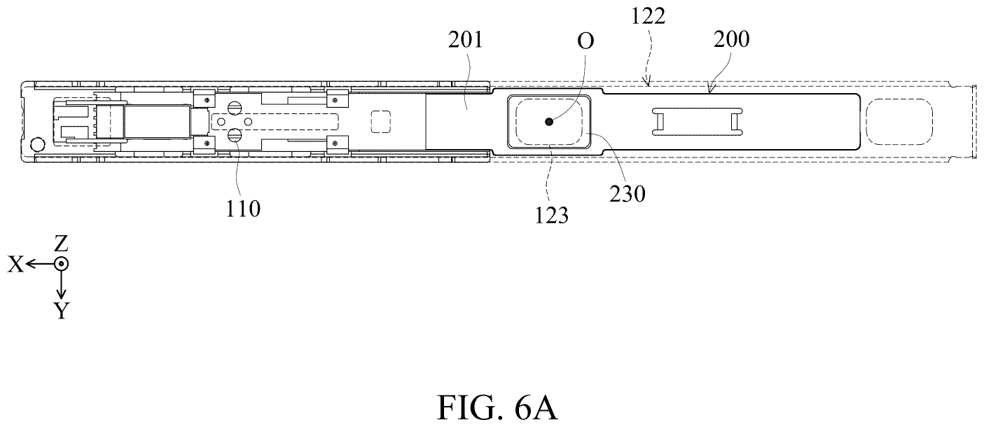

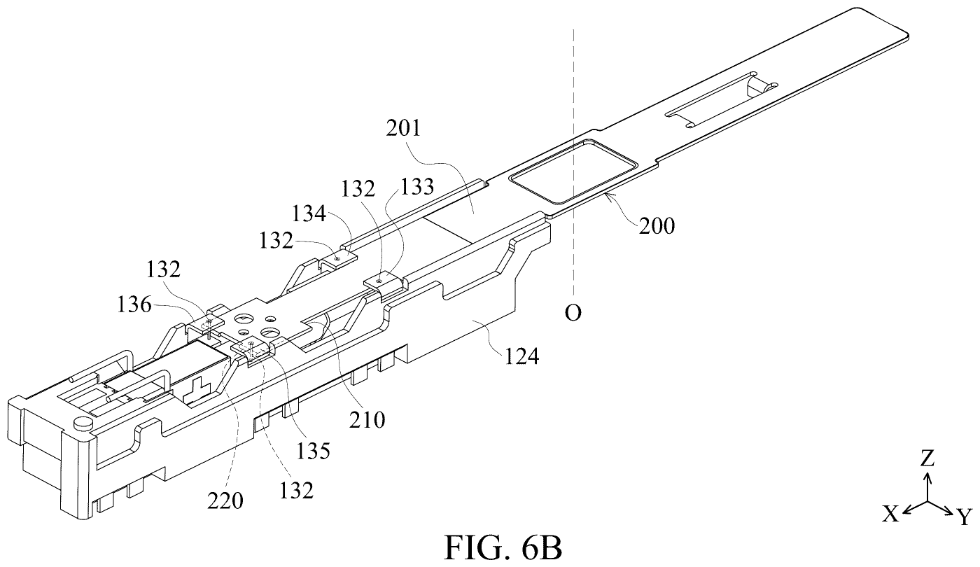

Next, please refer back to FIG. 2. The optical element 200 has a shielding part 201, a first edge 210, a second edge 220, and an opening 230. The shielding part 201 may be made of light-shielding material, such as SOMA. The first edge 210 and the second edge 220 may have rounded corners. When the movable part 110 is in the first position, the first edge 210 is in contact with the suspension wires 132, and when the movable part 110 is in the second position, the second edge 220 is in contact with the suspension wires 132, as will be described relative to FIG. 5A to FIG. 6B below. The rounded corners of the first edge 210 and the second edge 220 make them less likely to cause breakage of the suspension wires 132 when in contact. The opening 230 of the optical element 200 is larger than the opening 123 of the outer case 122. The optical element 200 is laser welded to the jointing part 112 of the movable part 110, thus driven by the transmitting element 144 of the driving assembly 140 to move between the first position and the second position relative to the fixed part 120.

As shown in FIG. 2, the driving assembly 140 includes a driving element 142, a transmitting element 144, a counterweight element 146, and a circuit assembly 148. The driving element 142 may have a rectangular shape and extend in the direction of axis L. The transmitting element 144 and the counterweight element 146 may be connected to the driving element 142 and are disposed on both sides of the driving element 142. The transmitting element 144 is connected to the base 124 of the fixed part 120 via a buffering element 126 (see FIG. 4). The driving element 142 is electrically connected to the circuit assembly 148. The circuit assembly 148 is electrically connected to an external controlling assembly (not shown). In some embodiments, the external controlling assembly may read the position information of the optical element 200 from the first circuit elements 133, 134 and the second circuit elements 135, 136 of the sensing assembly 130 and output control signals to the circuit assembly 148. Thus, electrical signals may be provided from the circuit assembly 148 to control the driving element 142.

In some embodiments, the material of the driving element 142 may include piezoelectric material. When an electric field (voltage) is applied to the surface of the piezoelectric material, the electric dipole moment is elongated due to the action of the electric field. The piezoelectric material resists the changing force and elongates in the direction of the electric field, thus generating mechanical deformation, which in turn drives the transmitting element 144 to move. For example, the electric dipole moment of the driving element 142 may be designed to extend in the X-axis direction to drive the transmitting element 144 to move in the X direction. The density of the counterweight element 146 may be greater than the density of the transmitting element 144 to generate a reaction force when the driving element 142 is driven. In some embodiments, the material of the transmitting element 144 may include carbon fiber, while the material of the counterweight element 146 may include metal.

Next, please refer to FIG. 4. FIG. 4 is a sectional view of the optical element driving mechanism 100 and the optical element 200 along line B-B in FIG. 1, according to certain aspects of the present disclosure. In some embodiments, a buffering element 126 surrounds the transmitting element 144. In some embodiments, the material of the buffering element 126 may include elastic material, such as silicone. In some embodiments, the buffering element 126 may be movably connected to the transmitting element 144 by frictional contact to define the position of the transmitting element 144.

Next, please refer to FIG. 5A. FIG. 5A is a top view of the optical element driving mechanism 100 and the optical element 200 in the first position, according to certain aspects of the present disclosure, for illustrative purposes, the outer case 122 of the fixed part 120 is shown in dashed lines. When the movable part 110 is in the first position, the shielding part 201 of the optical element 200 completely overlaps the opening 123 of the outer case 122. When the movable part 110 is in the first position, the optical axis O does not pass through the opening 230, and the first edge 210 of the optical element 200 is in contact with the suspension wires 132 (see FIG. 5B) at the first circuit elements 133 and 134. Meanwhile, the outer case 122 and the opening 230 of the optical element 200 also completely overlap. At this time, because the optical axis O does not pass through the opening 230 and does not pass through the optical module, the optical element 200 is in a closed state.

Next, please refer to FIG. 5B. FIG. 5B is a perspective view of the optical element driving mechanism 100 and the optical element 200 in the first position, according to certain aspects of the present disclosure. For illustrative purposes, the outer case 122 is not shown, and the first circuit elements 133 and 134 are shown transparent, the suspension wires 132 and the first edge 210 of the optical element 200 blocked by the first circuit elements 133 and 134 are shown in dashed lines. As shown, in the first position, the first edge 210 of the optical element 200 is in contact with the suspension wires 132 located near the first circuit elements 133 and 134, so that the first circuit elements 133 and 134 are conductive via the suspension wires 132 and the optical element 200. The first circuit elements 133, the suspension wires 132, the optical element 200, and the first circuit elements 134 are electrically connected. After the first circuit elements 133 and 134 are conducted, a signal is transmitted to the external controlling assembly, indicating that the optical element 200 is in the first position, in a closed state, and the optical axis O does not pass through the opening 230.

In some embodiments, when the circuit assembly 148 of the driving assembly 140 receives signals and causes the transmitting element 144 to move in the direction indicated by arrow C, the movement of the transmitting element 144 drives the optical element 200 to move. In detail, the gripping part 114 of the movable part 110 grips the transmitting element 144, and the jointing part 112 of the movable part 110 is welded to the optical element 200, therefore the movement of the transmitting element 144 drives the optical element 200 to move. The optical element 200 moves within a first range between the first position and the second position, wherein in the first range, the shielding part 201 of the optical element 200 at least partially overlaps the opening 123 of the outer case 122. The first edge 210 of the optical element 200 does not contact the suspension wires 132 (see FIG. 5B). The outer case 122 and the opening 230 of the optical element 200 at least partially overlap.

Next, please refer to FIG. 6A. FIG. 6A is a top view of the optical element driving mechanism 100 and the optical element 200 in the second position, according to certain aspects of the present disclosure. For illustrative purposes, the outer case 122 of the fixed part 120 is shown in dashed lines. The transmitting element 144 drives the movable part 110 and the optical element 200 to move from the first position to the second position in the direction of arrow C. When the movable part 110 is in the second position, the optical axis O passes through the opening 123 and the opening 230, and the second edge 220 of the optical element 200 is in contact with the suspension wires 132 of the second circuit elements 135 and 136 (see FIG. 6B). The shielding part 201 of the optical element 200 at least partially overlaps the outer case 122. The opening 230 of the optical element 200 completely overlaps the opening 123 of the outer case 122, and because the opening 230 of the optical element 200 is larger than the opening 123 of the outer case 122, the opening 123 of the outer case 122 is completely exposed through the opening 230 of the optical element 200. At this time, because the optical axis O passes through the opening 230 and passes through the optical module, the optical element 200 is in an open state.

Next, please refer to FIG. 6B. FIG. 6B is a perspective view of the optical element driving mechanism 100 and the optical element 200 in the second position, according to certain aspects of the present disclosure. For illustrative purposes, the outer case 122 is not shown, and the second circuit elements 135 and 136 are shown transparent, the suspension wires 132 and the second edge 220 of the optical element 200 blocked by the second circuit elements 135 and 136 are shown in dashed lines. As shown, in the second position, the second edge 220 of the optical element 200 is in contact with the suspension wires 132 of the second circuit elements 135 and 136, so that the second circuit elements 135 and 136 are conductive via the suspension wires 132 and the optical element 200. The second circuit elements 135, the suspension wires 132, the optical element 200, and the second circuit elements 136 are electrically connected. After the second circuit elements 135 and 136 are conducted, a signal is transmitted to an external controlling assembly, indicating that the optical element 200 is in the second position, in an open state, and the optical axis O passes through the opening 230.

In some embodiments, the distance between the first position and the second position, that is, the distance d1 between the first circuit elements 133 and 134 and the second circuit elements 135 and 136, is approximately one-quarter of the length d2 (see FIG. 5A) of the base 124.

In summary, according to some aspects of the present disclosure, the structure and function of the optical element driving mechanism and the optical element are described. The optical element driving mechanism includes a movable part, a fixed part, a sensing assembly, and a driving assembly. The optical element driving mechanism and the optical element together form an optical module.

According to some aspects of the present disclosure, the sensing assembly may sense the position of the optical element by electrical conduction and output position signals. By using position signals and control signals, the movement of the optical element may be controlled. By moving the optical element between two positions to allow or block the light through the optical element, the opening or closing of the optical element may be achieved. The sensing assembly senses the position of the optical element by electrical conduction, and with the configuration of suspension wires and circuit elements (transmitting elements), there is no need for conventional configurations such as Hall magnetic elements or coils, effectively saving internal space of the optical driving mechanism, thereby achieving miniaturization of the optical driving mechanism.

Although the disclosed embodiments have been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

While various embodiments of the present disclosure have been described above, it should be understood that they have been presented by way of example only, and not limitation. Numerous changes to the disclosed embodiments may be made in accordance with the disclosure herein, without departing from the spirit or scope of the disclosure. Thus, the breadth and scope of the present disclosure should not be limited by any of the above-described embodiments. Rather, the scope of the disclosure should be defined in accordance with the following claims and their equivalents.

The terminology used herein is for the purpose of describing particular examples only and is not intended to be limiting of the disclosure. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof, are used in either the detailed description and/or the claims, such terms are intended to be inclusive in a manner similar to the term “comprising.”.

What is claimed is:

1. An optical element driving mechanism, comprising:
a movable part, for connecting an optical element;
a fixed part, having an opening, for allowing light to pass through, wherein the movable part is movable relative to the fixed part; and
a sensing assembly for detecting the position of the movable part relative to the fixed part; wherein
when the movable part is in a first range, the optical element at least partially overlaps the opening.

2. The optical element driving mechanism as claimed in claim 1, wherein when the movable part is in a first position and a second position, the sensing assembly is electrically connected to the optical element.

3. The optical element driving mechanism as claimed in claim 2, wherein when the movable part is in the first position, the optical element is in a closed state.

4. The optical element driving mechanism as claimed in claim 2, wherein when the movable part is in the second position, the optical element is in an open state.

5. The optical element driving mechanism as claimed in claim 2, wherein the distance between the first position and the second position is approximately one-fourth of the total length of the optical element driving mechanism.

6. The optical element driving mechanism as claimed in claim 2, wherein when the movable part is in the first position and the second position, the sensing assembly is in contact with the optical element.

7. The optical element driving mechanism as claimed in claim 2, wherein when the movable part is in the first position, a first edge of the optical element is in contact with the sensing assembly.

8. The optical element driving mechanism as claimed in claim 7, wherein when the movable part is in the second position, a second edge of the optical element is in contact with the sensing assembly.

9. The optical element driving mechanism as claimed in claim 8, wherein the first edge and the second edge of the optical element in contact with the sensing assembly have rounded corners.

10. The optical element driving mechanism as claimed in claim 1, wherein the sensing assembly comprises a suspended wire and a circuit element, the suspended wire is laser welded to the circuit element.

11. The optical element driving mechanism as claimed in claim 10, wherein one end of the suspended wire is dangled in the air.

12. The optical element driving mechanism as claimed in claim 10, wherein the fixed part comprises an outer case, and an insulating element is disposed between the suspended wire and the outer case.

13. The optical element driving mechanism as claimed in claim 1, wherein the movable part comprises a jointing part, laser welded to the optical element.

14. The optical element driving mechanism as claimed in claim 1, further comprising a transmitting element, connected to the fixed part via a buffering element.
